(19) United States
(12) Patent Application Publication
(10) Pub. No.: US 2003/0177493 A1
(43) Pub. Date: Sep. 18, 2003

(54) Thumbnail display apparatus and thumbnail display program

(75) Inventor: Haruto Hirose, Kanagawa (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/368,625

(22) Filed: Feb. 20, 2003

(30) Foreign Application Priority Data
Mar. 14, 2002 (JP) 2002-71004

(51) Int. Cl. H04N 5/445; G06F 3/00; G06F 13/00

(52) U.S. Cl. 725/41; 725/37; 725/38; 725/39

(57) ABSTRACT

A thumbnail display apparatus for displaying thumbnail images of a plurality of movies, includes: a data storing unit for storing a plurality of movie data units corresponding to the movies; a thumbnail image creating unit for creating a plurality of thumbnail still images respectively corresponding to the movie data units stored in the data storing unit; and a displaying unit for simultaneously displaying the thumbnail still images created by the thumbnail image creating unit at different positions on a display screen for allowing any of the thumbnail still images to be selected, wherein the thumbnail image crating unit acquires a thumbnail movie obtained by making movie data corresponding to the selected thumbnail still image thumbnail, and the displaying unit displays the thumbnail movie at a position at which the selected thumbnail still image was arranged and displays other thumbnail still images that were not selected at different positions on the display screen simultaneously.

This patent application claims priority from a Japanese patent application No. 2002-71004 filed on Mar. 14, 2002, the contents of which are incorporated herein by reference.

### BACKGROUND OF THE INVENTION

1. Field of the Invention

The present invention relates to a thumbnail display apparatus and a thumbnail display program. More particularly, the present invention relates to a thumbnail display apparatus and a thumbnail display program which allow a user to browse outline of desired movie data in a short time.

2. Description of the Related Art

According to conventional techniques, in a case where a user wants to browse a movie file or an audio file stored in a computer, the computer displayed a file name corresponding to a respective movie file or a mark corresponding to a respective audio file in order to show the contents of the stored movie or audio file.

When the user instructed the computer to display a movie corresponding to a thumbnail still image on a display screen, the computer displayed the movie associated with that thumbnail still image on the entire display screen, thus increasing the resource of the computer and reducing the display speed of the computer. Therefore, it took a long time for the user to browse the outline of the desired movie data.

### SUMMARY OF THE INVENTION

Therefore, it is an object of the present invention to provide a thumbnail display apparatus and a thumbnail display program, which are capable of overcoming the above drawbacks accompanying the conventional art. The above and other objects can be achieved by combinations described in the independent claims. The dependent claims define further advantageous and exemplary combinations of the present invention.

According to the first aspect of the present invention, a thumbnail display apparatus for displaying thumbnail images of a plurality of movies, comprises: a data storing unit operable to store a plurality of movie data units corresponding to the movies; a thumbnail image creating unit operable to create a plurality of thumbnail still images respectively corresponding to the movie data units stored in the data storing unit; and a displaying unit operable to simultaneously display the plurality of thumbnail still images created by the thumbnail image creating unit at different positions on a display screen for allowing any of the thumbnail still images to be selected, wherein the thumbnail image crating unit acquires a thumbnail movie obtained by making movie data corresponding to the selected thumbnail still image thumbnail, and the displaying unit displays the thumbnail movie at a position at which the selected thumbnail still image was arranged and displays other thumbnail still images that were not selected at different positions on the display screen simultaneously.

The thumbnail display apparatus may further comprise a thumbnail image storing unit operable to store the plurality of thumbnail still images created by the thumbnail image creating unit in such a manner that the plurality of thumbnail still images correspond to associated movie-data identifying information units for identifying the plurality of movie data units, respectively, wherein the thumbnail image storing unit stores audio data units to correspond to the movie-data identifying information units, respectively, the thumbnail image creating unit acquires, when a plurality of ones of the plurality of thumbnail still images were selected, audio data units corresponding to movie-data identifying information units corresponding to the selected thumbnail still images, respectively, from the thumbnail image storing unit, and the displaying unit outputs audio in such a manner that the audio is heard from positions corresponding to positions at which the selected thumbnail still images were arranged.

The thumbnail display apparatus may further comprise a thumbnail selecting unit operable to select one of the plurality of thumbnail still images on the display screen, wherein the thumbnail image creating unit acquires, in a case where a position indicated by the thumbnail selecting unit overlaps a position of the selected one of the thumbnail still images on the display screen of the display unit, the thumbnail movie corresponding to the selected thumbnail still image, and the display unit displays the thumbnail movie created by the thumbnail image creating unit at the position at which the selected thumbnail still image was arranged on the display screen.

The thumbnail display apparatus may further comprise a thumbnail selecting unit operable to select one of the plurality of thumbnail still images on the display screen. The thumbnail image storing unit may store a plurality of units of thumbnail image identifying information for identifying the plurality of thumbnail still images to correspond to one another; the thumbnail creating unit may create, in a case where the thumbnail selecting units selected any of the plurality of thumbnail still images, thumbnail movies of movie data units that are respectively associated with the thumbnail image identifying information units corresponding to one another; and the display unit may display the thumbnail movies created by the thumbnail image creating unit simultaneously.

The thumbnail display apparatus may further comprise: a thumbnail image storing unit operable to store the plurality of thumbnail still images created by the thumbnail image creating unit; and a thumbnail selecting unit operable to select one of the plurality of thumbnail still images on the display screen. The thumbnail creating unit may acquire, in a case where the thumbnail selecting unit stopped selecting the one of the plurality of thumbnail still images, acquires from the thumbnail image storing unit the thumbnail still image that was presented on the display screen at a time when the selected one of the plurality of thumbnail still images was selected; and the display unit displays the thumbnail still image acquired by the thumbnail image creating unit at a position on the display screen at which the selected one of the plurality of thumbnail still images was arranged.

The thumbnail display apparatus may further comprise a thumbnail selecting unit operable to select one of the plurality of thumbnail still images. The thumbnail image creating unit may create, when the thumbnail selecting unit stopped selecting the one of the plurality of thumbnail still images, a thumbnail image of a flame that was presented at a time at which selection of the one of the plurality of thumbnail still images was stopped, and causes the display unit to display the created thumbnail image.

The data storing unit may store audio data to be associated with each of flames of each movie data unit; and the thumbnail image creating unit may select flames of the movie data units, with each of which the audio data having a larger size than a predetermined data size is associated, and creates the thumbnail still image by making the selected flames thumbnail.

The thumbnail display apparatus may further comprise: a calculating unit operable to calculate a coincidence between adjacent flames of a plurality of flames constituting each movie data unit stored in the data storing unit; and an extracting unit operable to determine whether or not the coincidence is smaller than a reference value and to extract a latter one of the adjacent flames for which the coincidence was determined to be smaller than the reference value. The thumbnail image creating unit may create a thumbnail image of the latter flame extracted by the extracting unit as a thumbnail still image corresponding to the movie data.

The thumbnail display apparatus may further comprise a movie data selecting unit operable to select a movie data unit having presentation time larger than predetermined time, from the movie data units stored in the data storing unit. The calculating unit may calculate the coincidence between the adjacent flames only for the movie data unit selected by the movie data selecting unit; the extracting unit may extract a latter one of the adjacent flames for which the coincidence was determined to be smaller than the reference value; and the thumbnail image creating unit may create a thumbnail image of the latter flame extracted by the extracting unit as a thumbnail still image corresponding to the movie data unit.

The display unit may present the movie data unit containing the flames for which the coincidence was determined to be smaller than the reference value in such a manner that the flames for which the coincidence was determined to be smaller than the reference value were subjected to image processing different from that for flames for which the coincidence was determined to be larger than the reference value.

The thumbnail image creating unit may determine whether or not presentation time of each of the movie data units stored in the data storing unit is shorter than predetermined time, and may create, for movie data unit for which the presentation time was determined to be shorter than the predetermined time, a thumbnail movie by making the movie data unit thumbnail.

According to the second aspect of the present invention, a thumbnail display program for causing a computer to display thumbnail images of a plurality of movies, comprises: a data storing module instructing the computer to store a plurality of movie data units corresponding to the movies; a thumbnail image creating module instructing the computer to create a plurality of thumbnail still images respectively corresponding to the movie data units stored; and a display module instructing the computer to simultaneously display the plurality of thumbnail still images created in accordance with the instruction from the thumbnail image creating module at different positions on a display screen for allowing any of the thumbnail still images to be selected, wherein the thumbnail image creating module instructs the computer to acquire a thumbnail movie obtained by making movie data corresponding to the selected thumbnail still image thumbnail, and the display module instructs the computer to display the thumbnail movie at a position at which the selected thumbnail still image was arranged and to display other thumbnail still images that were not selected at different positions on the display screen simultaneously.

The thumbnail display program may further comprise a thumbnail image storing module instructing the computer to store the plurality of thumbnail still images created in accordance with the instruction from the thumbnail image creating module in such a manner that the plurality of thumbnail still images correspond to associated movie-data identifying information units for identifying the plurality of movie data units, respectively. The thumbnail image storing module may instruct the computer to store audio data units to correspond to the movie-data identifying information units, respectively; the thumbnail image creating module may instruct the computer to acquire, when a plurality of ones of the plurality of thumbnail still images were selected, audio data units corresponding to movie-data identifying information units corresponding to the selected thumbnail still images, respectively, from the thumbnail image storing module and the display module may instruct the computer to output audio in such a manner that the audio is heard from positions corresponding to positions at which the selected thumbnail still images were arranged.

The thumbnail display program may further comprise a thumbnail selecting module operable to select one of the plurality of thumbnail still images on the display screen. The thumbnail image creating module may instruct the computer to acquire, in a case where a position indicated by the thumbnail selecting module overlaps a position of the selected one of the thumbnail still images on the display screen, the thumbnail movie corresponding to the selected thumbnail still image; and the display module may instruct the computer to display the thumbnail movie created by the thumbnail image creating module at the position at which the selected thumbnail still image was arranged on the display screen.

The thumbnail display program may further comprise a thumbnail selecting module operable to select one of the plurality of thumbnail still images on the display screen. The thumbnail image storing module may instruct the computer to store a plurality of units of thumbnail image identifying information for identifying the plurality of thumbnail still images to correspond to one another; in a case where the thumbnail selecting units selected any of the plurality of thumbnail still images, the thumbnail creating module may instruct the computer to create thumbnail movies of movie data units that are respectively associated with the thumbnail image identifying information units corresponding to one another; and the display module may instruct the computer to simultaneously display the thumbnail movies thus created.

The thumbnail display program may further comprise: a thumbnail image storing module instructing the computer to store the plurality of thumbnail still images created in accordance with the instruction from the thumbnail image creating module; and a thumbnail selecting module operable to select one of the plurality of thumbnail still images on the display screen. In a case where the thumbnail selecting module stopped selecting the one of the plurality of thumbnail still images, the thumbnail creating module may instruct the computer to acquire from the thumbnail image storing module the thumbnail still image that was presented on the display screen at a time when the selected one of the plurality of thumbnail still images was selected. The display module may instruct the computer to display the thumbnail still image thus acquired at a position on the display screen at which the selected one of the plurality of thumbnail still images was arranged.

The thumbnail display program may further comprise a thumbnail selecting module operable to select one of the plurality of thumbnail still images. When the thumbnail selecting module stopped selecting the one of the plurality of thumbnail still images, the thumbnail image creating module may instruct the computer to create a thumbnail image of a flame that was presented at a time at which selection of the one of the plurality of thumbnail still images was stopped and may instruct the computer to display the created thumbnail image.

The data storing module may instruct the computer to store audio data to be associated with each of flames of each movie data unit; and the thumbnail image creating module may instruct the computer to select flames of the movie data units, with each of which the audio data having a larger size than a predetermined data size is associated and may instruct the computer to create the thumbnail still image by making the selected flames thumbnail.

The thumbnail display program may further comprise: a calculating module instructing the computer to calculate a coincidence between adjacent flames of a plurality of flames constituting each movie data unit stored in accordance with the instruction from the data storing module; and an extracting module instructing the computer to determine whether or not the coincidence is smaller than a reference value and to extract a latter one of the adjacent flames for which the coincidence was determined to be smaller than the reference value. The thumbnail image creating module may instruct the computer to create a thumbnail image of the latter flame thus extracted as a thumbnail still image corresponding to the movie data.

The thumbnail display program may further comprise a movie data selecting module instructing the computer to select a movie data unit having presentation time larger than predetermined time, from the stored movie data units. The calculating module may instruct the computer to calculate the coincidence between the adjacent flames only for the movie data unit selected by the movie data selecting module; the extracting module may instruct the computer to extract a latter one of the adjacent flames for which the coincidence was determined to be smaller than the reference value; and the thumbnail image creating module may instruct the computer to create a thumbnail image of the latter flame extracted by the extracting unit as a thumbnail still image corresponding to the movie data unit.

The display module may instruct the computer to present the movie data unit containing the flames for which the coincidence was determined to be smaller than the reference value in such a manner that the flames for which the coincidence was determined to be smaller than the reference value were subjected to image processing different from that for flames for which the coincidence was determined to be larger than the reference value.

The thumbnail image creating module may instruct the computer to determine whether or not presentation time of each of the stored movie data units is shorter than predetermined time, and may instruct the computer to create, for movie data unit for which the presentation time was determined to be shorter than the predetermined time, a thumbnail movie by making the movie data unit thumbnail.

The summary of the invention does not necessarily describe all necessary features of the present invention. The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

FIG. 1 illustrates an exemplary structure of a thumbnail display apparatus according to an embodiment of the present invention.

FIG. 2 shows an exemplary database structure of a data storing unit 10 in form of table.

FIG. 3 shows an exemplary database structure of a thumbnail image storing unit 14 in form of table.

FIG. 4 shows a hardware configuration of the thumbnail display apparatus 100.

FIG. 5 shows an example of a procedure of the thumbnail display apparatus 100.

FIG. 6 shows another example of the procedure of the thumbnail display apparatus 100.

FIG. 7 shows still another example of the procedure of the thumbnail display apparatus 100.

FIG. 8 shows an example of a more detailed procedure in Step S12 for creating a thumbnail still image from movie data.

FIG. 9 shows another example of the more detailed procedure in Step S12 for creating the thumbnail still image from the movie data.

FIG. 10 shows an example of a more detailed procedure in Step S48 in FIG. 9, for acquiring the movie data from the data storing unit 10.

FIG. 11 shows a more detailed procedure between (1) and (2) in FIG. 10.

### DETAILED DESCRIPTION OF THE INVENTION

The invention will now be described based on the preferred embodiments, which do not intend to limit the scope of the present invention, but exemplify the invention. All of the features and the combinations thereof described in the embodiment are not necessarily essential to the invention.

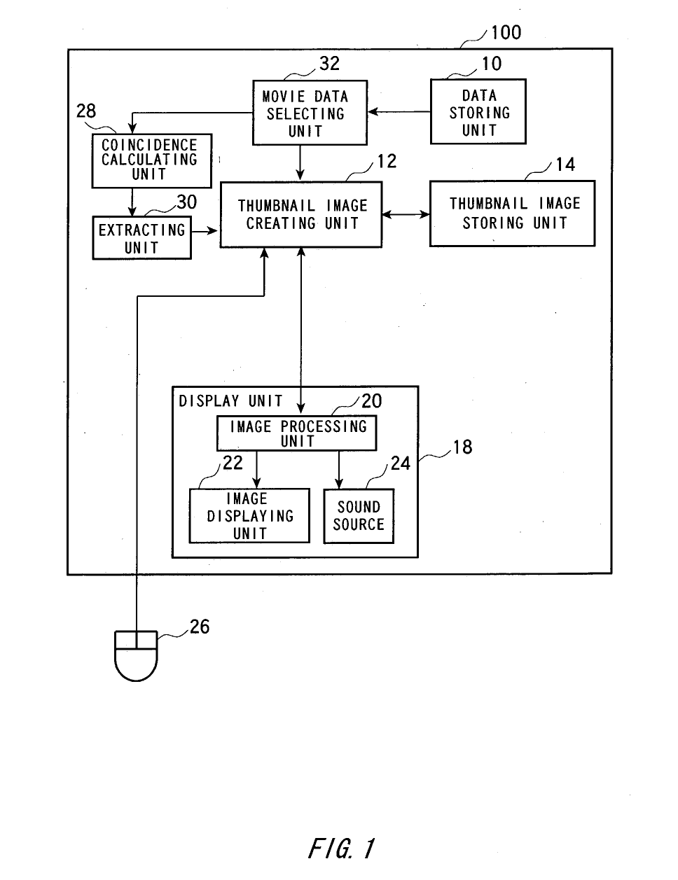

FIG. 1 illustrates an exemplary structure of a thumbnail display apparatus according to an embodiment of the present invention. The thumbnail display apparatus 100 displays a plurality of thumbnail images of a plurality of movies. The thumbnail display apparatus 100 includes a data storing unit 10, a thumbnail image creating unit 12, a thumbnail image storing unit 14, a display unit 18, a coincidence calculating unit 28, an extracting unit 30, a movie data selecting unit 32, and a thumbnail selecting unit 26.

The data storing unit 10 stores data of a plurality of movies.

The thumbnail image creating unit 12 creates a plurality of thumbnail still images respectively corresponding to a plurality of movie data units stored in the data storing unit 10. Moreover, the thumbnail image creating unit 12 acquires a thumbnail movie corresponding to one of the thumbnail still images that was selected by a user. That is, the thumbnail movie is a movie obtained by changing one movie data unit into a thumbnail. In addition, the thumbnail image creating unit 12 acquires condensed audio data corresponding to the thumbnail still image selected by the user. The condensed audio data is data obtained by compressing audio associated with the movie data.

The display unit 18 simultaneously displays a plurality of thumbnail still images acquired by the thumbnail image creating unit 12 at different positions on a display screen in order to allow the user to select any of the thumbnail still images. When the user selected one thumbnail still image corresponding to the movie data to be displayed, the display unit 18 displays the thumbnail movie acquired by the thumbnail image creating unit 12 at a position on the screen at which the selected thumbnail still image was arranged, and also displays the other thumbnail still images that were not selected at different positions on the display screen simultaneously.

The display unit 18 has an image processing unit 20, an image displaying unit 22 and a sound source 24. The image processing unit 20 performs image processing for causing the image acquired by the thumbnail image creating unit 12 to gradually disappear or appear in an appropriate manner. The image displaying unit 22 displays an image such as the thumbnail still image and thumbnail movie acquired by the thumbnail image creating unit 12. The sound source 24 outputs audio associated with the thumbnail still image and thumbnail movie.

The thumbnail selecting unit 26 selects one of a plurality of thumbnail still images on the display screen. In other words, the user selects one of a plurality of thumbnail still images presented on the display screen of the display unit by using the thumbnail selecting unit 26. The thumbnail selecting unit 26 includes a device that can select an element presented on the display screen of the display unit 18, such as a pointer and a mouse.

The thumbnail image storing unit 14 stores a plurality of thumbnail still images acquired by the thumbnail image creating unit 12 and condensed audio data associated with each of the thumbnail still images in such a manner that each thumbnail still image and the associated condensed audio data correspond to associated movie-data identifying information for identifying movie data.

The coincidence calculating unit 28 calculates coincidence between adjacent ones of a plurality of flames constituting movie data stored in the data storing unit 10. The extracting unit 30 determines whether or not the coincidence calculated by the coincidence calculating unit 28 is smaller than a reference value and, when the coincidence between certain flames was determined to be smaller than the reference value, outputs the latter one of those flames to the thumbnail image creating unit 12 after extracting the latter flame from the movie data.

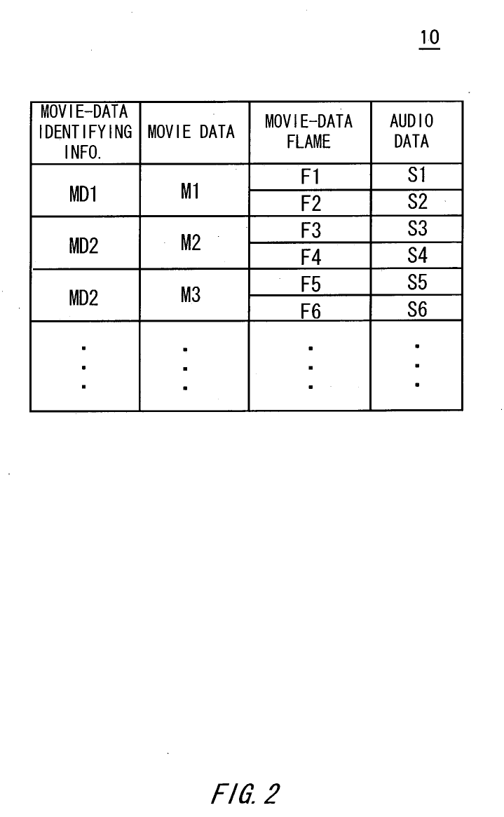

FIG. 2 shows a database structure of the data storing unit 10 in form of table. The data storing unit 10 stores movie data and audio data that is associated with each flame of the movie data so as to correspond to movie-data identifying information for identifying the movie data. For example, the data storing unit 10 stores movie data M1 so as to correspond to movie-data identifying information MD1. The data storing unit 10 also stores audio data units S1 and S2 that are respectively associated with flames F1 and F2 constituting the movie data M1. Since the data storing unit 10 has the aforementioned structure, the thumbnail image creating unit 12 can acquire the movie data and the audio data from the data storing unit 10 by using the movie-data identifying information.

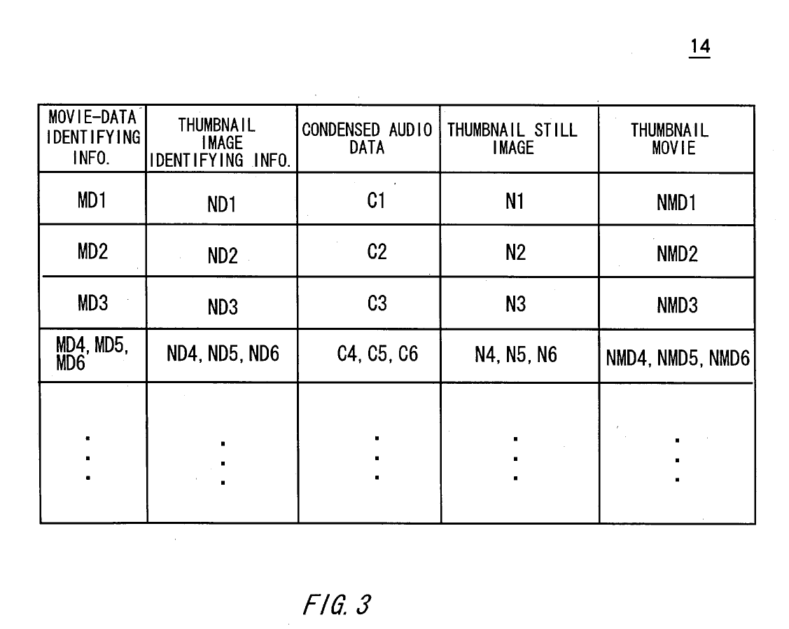

FIG. 3 shows a database structure of the thumbnail image storing unit 14 in form of table. The thumbnail image storing unit 14 stores thumbnail image identifying information, condensed audio data, a thumbnail still image and a thumbnail movie. The thumbnail image identifying information is information used for identifying the thumbnail image acquired by the thumbnail image creating unit 12. The condensed audio data is data obtained by compressing audio data associated with movie data. The thumbnail still image is a still image created by making a flame included in the associated movie data thumbnail by means of the thumbnail image creating unit 12. The thumbnail movie is a movie created by making the movie data thumbnail by means of the thumbnail image creating unit 12.

For example, the thumbnail image storing unit 14 stores thumbnail image identifying information ND1, condensed audio data C1, a thumbnail still image N1 and a thumbnail movie NMD1 so as to correspond to the movie-data identifying information MD1.

In a case where the user selected the thumbnail still image N1 on the display screen of the display unit 18, the thumbnail image crating unit 12 acquires the condensed audio data C1 and the thumbnail movie NMD1 that correspond to the thumbnail image identifying information ND1 from the thumbnail image storing unit 14 because the thumbnail identifying information corresponding to the thumbnail still image N1 is information ND1. In this case, the thumbnail image creating unit 12 creates the thumbnail movie of the movie data M1 in advance and stores it in the thumbnail image storing unit 14, before the selection of thumbnail still image by the user.

The thumbnail image creating unit 12 may create at the time at which the user selected a certain thumbnail still image the thumbnail movie of the movie data corresponding to the selected thumbnail still image. In this case, the thumbnail image creating unit 12 recognizes that the movie-data identifying information MD1 corresponds to the thumbnail still image N1 in the thumbnail image storing unit 14. Moreover, the thumbnail image creating unit 12 acquires the movie data M1 and audio data S1 and S2 that correspond to the movie-data identifying information MD1, from the data storing unit 10 so as to create a thumbnail movie of the movie data M1.

The thumbnail image storing unit 14 stores the condensed audio data so as to correspond to the associated movie-data identifying information. Thus, when a plurality of thumbnail still images were selected, the thumbnail image creating unit 12 acquires condensed audio data units that correspond to the thumbnail still images, respectively, from the thumbnail image storing unit 14. In this case, the display unit 18 outputs audio in such a manner that the user hears the audio or sound generate from positions corresponding to the positions of the thumbnail still images.

The thumbnail image storing unit 14 may store a plurality of units of thumbnail image identifying information so as to correspond to one another. In FIG. 3, for example, the thumbnail image storing unit 14 stores a plurality of units of thumbnail image identifying information ND4, ND5 and ND6 so as to correspond to one another. Thus, when the user selected a thumbnail still image N4 from a plurality of thumbnail still images N4, N5 and N6, the thumbnail image creating unit 12 acquires the associated thumbnail image identifying information units ND4, ND5 and ND6 that correspond to one another and associated thumbnail movies NMD4, NMD5 and NMD6. Then, the display unit 18 presents the thumbnail movies NMD4, NMD5 and NMD6 acquired by the thumbnail image creating unit 12 on the display screen simultaneously.

The thumbnail display apparatus 100 can acquire a thumbnail movie of movie data corresponding to a thumbnail still image selected by the user, by using the data storing unit 10 and the thumbnail image storing unit 14. Thus, the thumbnail display apparatus 100 can present the thumbnail movie only for the movie data corresponding to the selected thumbnail still image. For the other thumbnail still images that were not selected, the thumbnail display apparatus 100 presents those thumbnail still images.

Since the thumbnail display apparatus 100 presents the thumbnail movie only for the movie data corresponding to the thumbnail still image selected by the user, the increase of the resource of a computer caused by displaying thumbnails can be suppressed, thereby increasing the speed for presenting the thumbnails as compared with the speed in a conventional displaying apparatus. Therefore, according to the thumbnail display apparatus 100, the user can browse the outline of desired movie data.

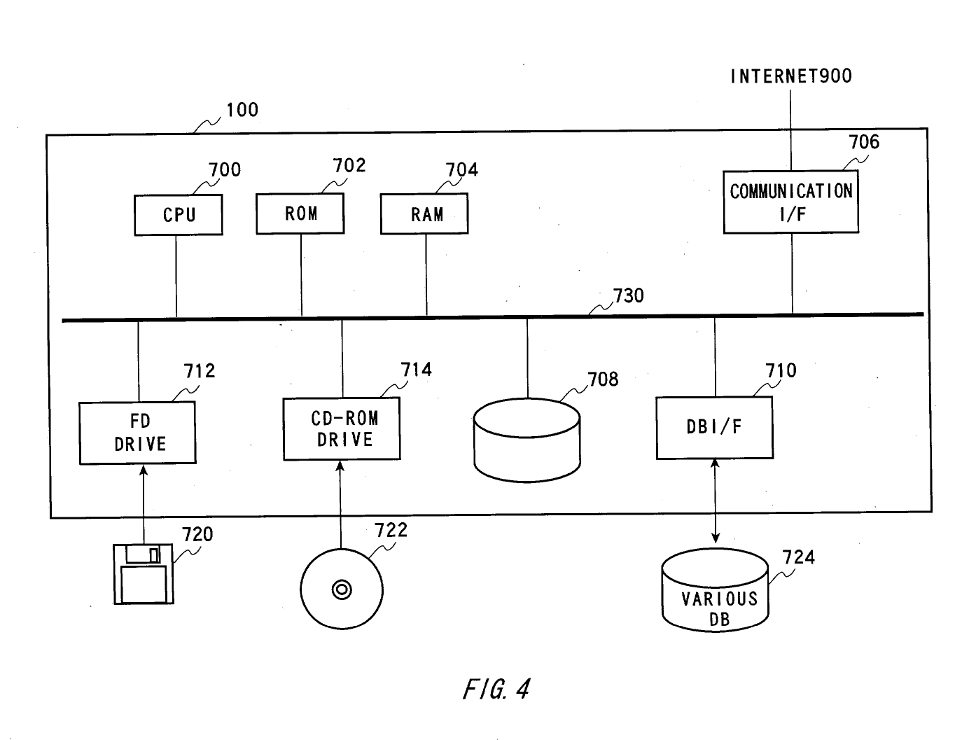

FIG. 4 illustrates a hardware configuration of the thumbnail display apparatus 100. The thumbnail display apparatus 100 includes a CPU 700; a ROM 702; a RAM 704; a communication interface 706; a hard disk drive 708; a database interface 710; a floppy disk drive 712; and a CD-ROM drive 714 that are connected to a bus 730. The CPU 700 operates in accordance with at least one program stored in the ROM 702 and RAM 704. The communication interface 706 communicates with the outside of the apparatus 100 via the Internet 10. The database interface 710 writes data into a database and updates the contents of the database. The hard disk drive 708 as an exemplary storage device stores setting information and the program in accordance with which the CPU 700 operates.

The floppy disk drive 712 reads data or a program from a floppy disk 720 so as to provide the data or program to the CPU 700. The CD-ROM drive 714 reads data or a program from a CD-ROM 722 so as to provide the data or program to the CPU 700. The communication interface 706 is connected to the Internet 10 to transmit/receive data. The database interface 710 is connected to a various database 724 to transmit/receive data.

Software executed by the CPU 700 is provided to a user while being stored in a recording medium such as a floppy disk 720 or a CD-ROM 722. The software stored in the recording medium may be compressed or non-compressed. The software is installed from the recording medium to the hard disk drive 708 and is then read into the RAM 704 so as to be executed by the CPU 700.

The software to be provided while being stored in the recording medium, that is, the software to be installed into the hard disk drive 708 includes as functional components a data storing module instructing a computer to store a plurality of movie data units, a thumbnail image creating module instructing the computer to create a plurality of thumbnail still images respectively corresponding to the movie data units, and a display module instructing the computer to simultaneously display the thumbnail still images created in accordance with the instruction from the thumbnail image creating module at different positions on the display screen for selection. The thumbnail image creating module causes the computer to acquire a thumbnail movie obtained by changing the movie data corresponding to the selected thumbnail still image into a thumbnail, and the display module then causes the computer to display the thumbnail movie at a position at which the selected thumbnail still image was arranged and to display the other thumbnail still images that were not selected at their positions different from one another simultaneously. Processes that the respective modules instruct the CPU 700 of the computer to perform are the same as the functions and operations of the corresponding components of the thumbnail display apparatus 100 of the present embodiment, and therefore the description thereof is omitted.

The floppy disk 720 or CD-ROM 722 as examples of the recording medium, shown in FIG. 4, can store a part of or all the functions and operations of the thumbnail display apparatus 100 in all the embodiments described in the present application.

The aforementioned program may be read directly to the RAM from the recording medium so as to be executed, or may be read to the RAM to be executed after being installed into the hard disk drive. Moreover, the aforementioned program may be stored in a single recording medium or a plurality of recording media. In addition, the stored program may be coded.

As the recording medium, other than the floppy disk or CD-ROM, an optical recording medium such as a DVD or PD, a magneto-optical recording medium such as an MD, a tape-like medium, a magnetic recording medium, a semiconductor memory such as an IC card or miniature card can be used. Moreover, a storage device such as a hard disk or RAM provided on a server system connected to an exclusive communication network or the Internet may be used as the recording medium. In this case, the program is provided to the thumbnail display apparatus 100 via the communication network.

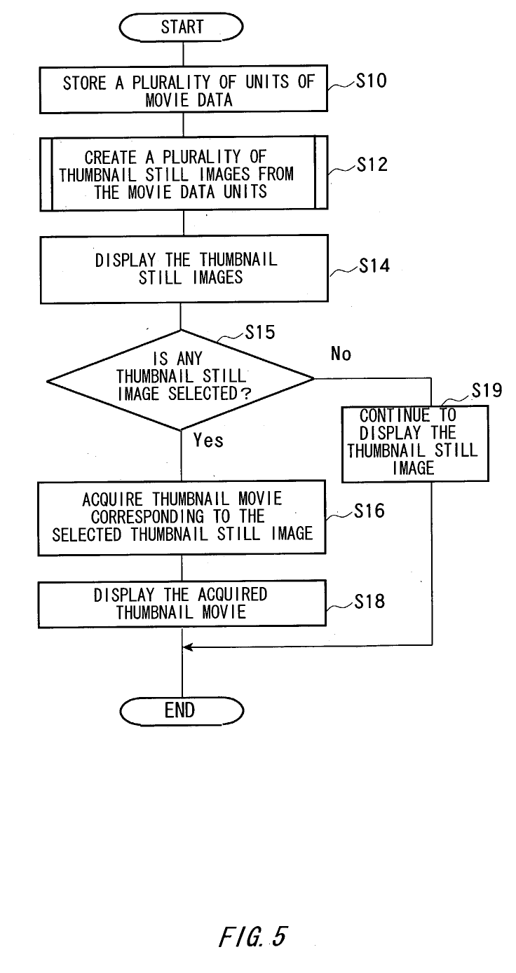

FIG. 5 shows an example of the procedure of the thumbnail display apparatus 100. First, the data storing unit 10 stores a plurality of movie data units (Step S10). Then, the thumbnail image creating unit 12 creates a plurality of thumbnail still images respectively corresponding to the movie data units stored in the data storing unit 10 (Step S12). The display unit 18 then displays the thumbnail still images created by the thumbnail image creating unit 12 at different positions on the display screen simultaneously (Step S14). Then, the thumbnail display apparatus 100 determines whether or not the user selected any of the thumbnail still images (Step S15).

When the user selected any of the thumbnail still image (Yes, in Step S15), the thumbnail image creating unit 12 acquires a thumbnail movie obtained by making the movie data corresponding to the selected thumbnail still image a thumbnail. More specifically, the thumbnail image creating unit 12 creates the thumbnail movie of each movie data unit so as to store it in the thumbnail image storing unit 14 before the selection of thumbnail still image by the user, and, when the user selected a certain thumbnail still image, acquires the thumbnail movie corresponding to the selected thumbnail still image from the thumbnail image storing unit 14. Moreover, the thumbnail image creating unit 12 may create the thumbnail movie from the movie data corresponding to the selected thumbnail still image when the user selected the thumbnail still image.

Then, the display unit 18 displays the thumbnail movie at a position on the display screen at which the selected thumbnail still image was arranged and simultaneously displays the other thumbnail still images that were not selected at different positions on the display screen (Step S18).

In a case where the user selected no thumbnail still image (No in Step S15), the thumbnail display apparatus 100 continues to display a plurality of thumbnail still images (Step S19) and finishes the process.

Methods for selecting a thumbnail still image include a method in which the thumbnail still image is clicked to be selected by means of the thumbnail selecting unit 26 such as a pointer, and other methods. For example, when a position on the display screen of the display unit 18, that is indicated by the thumbnail selecting unit 26, overlaps a position at which a certain thumbnail still image is arranged, the thumbnail image creating unit 12 may acquire the thumbnail movie of the movie data corresponding to that thumbnail still image.

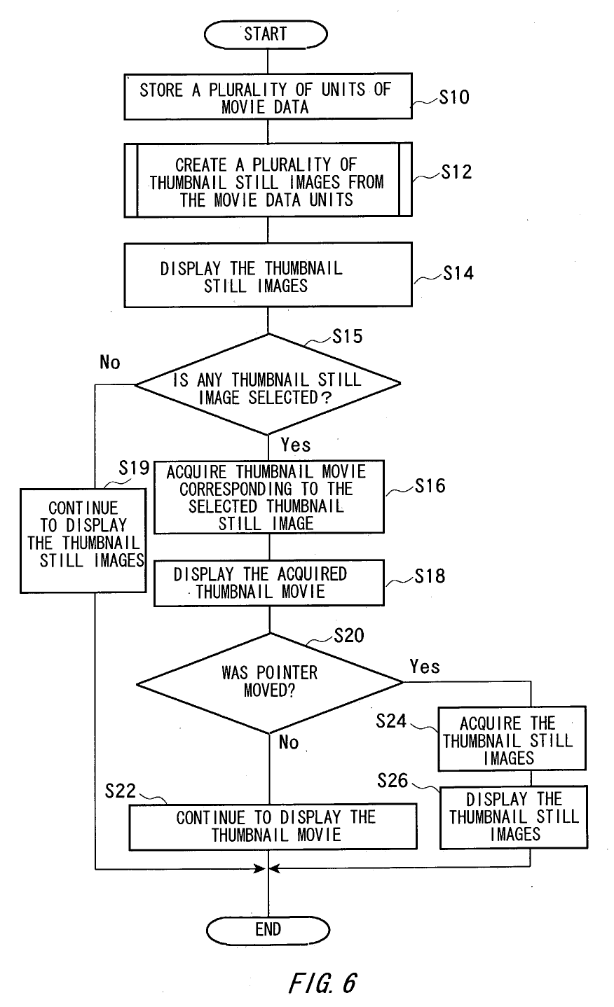

FIG. 6 shows another example of the procedure of the thumbnail display apparatus 100. First, the data storing unit 10 stores a plurality of movie data units (Step S10). Then, the thumbnail image crating unit 12 creates a plurality of thumbnail still images respectively corresponding to the movie data units stored in the data storing unit 10 (Step S12). The display unit 18 then displays the thumbnail still images created by the thumbnail creating unit 12 at different positions on the display screen simultaneously (Step S14). Then, the thumbnail image creating unit 12 determines whether or not the user selected the thumbnail still image to be displayed (Step S15).

When the user selected any of the thumbnail still images (Yes in Step S15), the thumbnail image creating unit 12 acquires a thumbnail movie obtained by making the movie data corresponding to the selected thumbnail still image a thumbnail (Step S16). The display unit 18 displays the thumbnail movie at the position on the display screen at which the selected thumbnail still image was arranged and displays the other thumbnail still images that were not selected at different positions on the display screen simultaneously (Step S18).

Then, the thumbnail image creating unit 12 determines whether or not the thumbnail selecting unit 26 stopped selecting the thumbnail still image that had been selected (Step S20). For example, in a case where the thumbnail selecting unit 26 is a pointer, the thumbnail image creating unit 12 determines whether or not the position pointed by the pointer was moved away from the position of the thumbnail still image that had been pointed.

When the thumbnail selecting unit 26 stopped selecting the thumbnail still image that had been selected (Yes in Step S20), that is, when the pointer was moved away from that thumbnail still image, the thumbnail image creating unit 12 acquires the thumbnail still image that was presented on the display screen at the time of the selection from the thumbnail image storing unit 14 (Step S24). The display unit 18 displays the thumbnail still image acquired by the thumbnail image creating unit 12 at the position on the display screen at which the selected thumbnail still image was arranged (Step S26).

On the other hand, in a case where the thumbnail selecting unit 26 still selects the thumbnail still image that had been selected (No in Step S20), that is, in a case where the pointer is not away from the selected thumbnail still image, the display unit 18 continues to display the thumbnail still image and the thumbnail movie (Step S22).

In a case where the user selects no thumbnail still image (No in Step S15), the thumbnail display apparatus 100 continues to display a plurality of thumbnail still images (Step S19), and finishes the procedure.

In the example shown in FIG. 6, in a case where the user stopped selecting the thumbnail still image that had been selected, the thumbnail display apparatus 100 displays the thumbnail still image that was presented on the display screen at the time of the selection. That is, the thumbnail display apparatus 100 displays a plurality of thumbnail still images presented on the initial screen that is the screen before the user made selection. Thus, the user can bring the display screen of the display unit 18 back to the initial screen before the user made the selection.

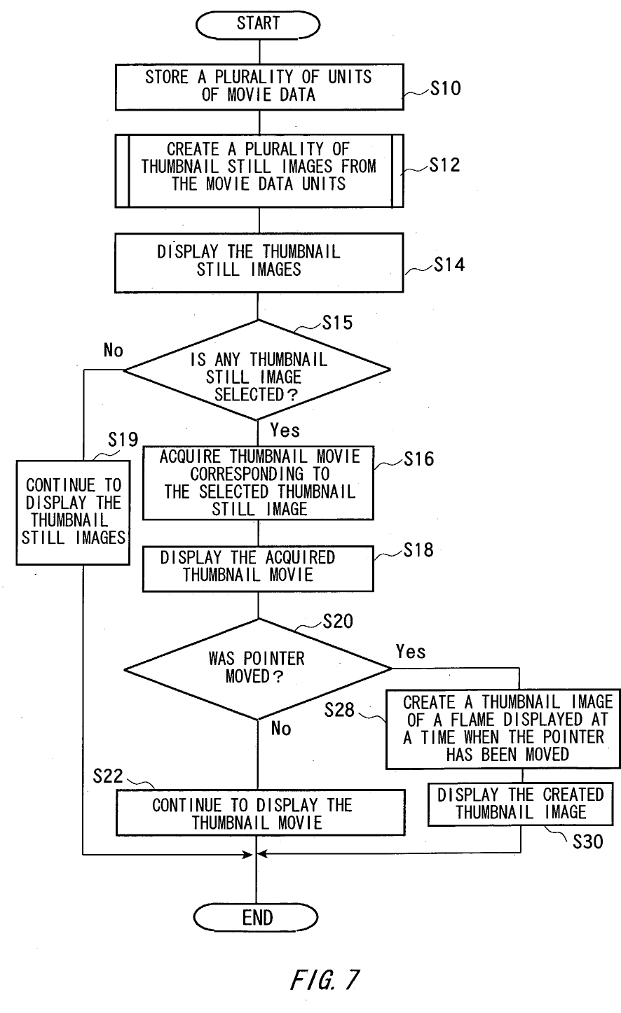

FIG. 7 shows still another example of the procedure of the thumbnail display apparatus 100. In the example shown in FIG. 7, the procedure is the same as that shown in FIG. 6 except for the procedure after determination that the pointer was moved away from the thumbnail still image that had been selected (Yes in Step S20). Thus, the description of the same procedure is omitted.

In a case where the thumbnail selecting unit 26 stopped selecting the thumbnail still image that had been selected (Yes in Step S20), that is, the user moved the position of the pointer away from the position of the thumbnail still image that had been selected, the thumbnail image creating unit 12 creates a thumbnail image of the flame that was presented at the time at which the selection was stopped (Step S28). The display unit 18 displays the thumbnail image created by the thumbnail image creating unit 12 (Step S30).

In the example of FIG. 7, when the user stopped selecting the thumbnail still image that had been selected, the thumbnail display apparatus 100 displays the thumbnail image of the flame that was presented at the time when the selection was stopped. Thus, the user can cause the thumbnail display apparatus 100 to display the thumbnail still image of the flame in the thumbnail movie presented on the display screen, that the user wants to watch, by moving the pointer away from the position of the selected thumbnail still image at a desired timing.

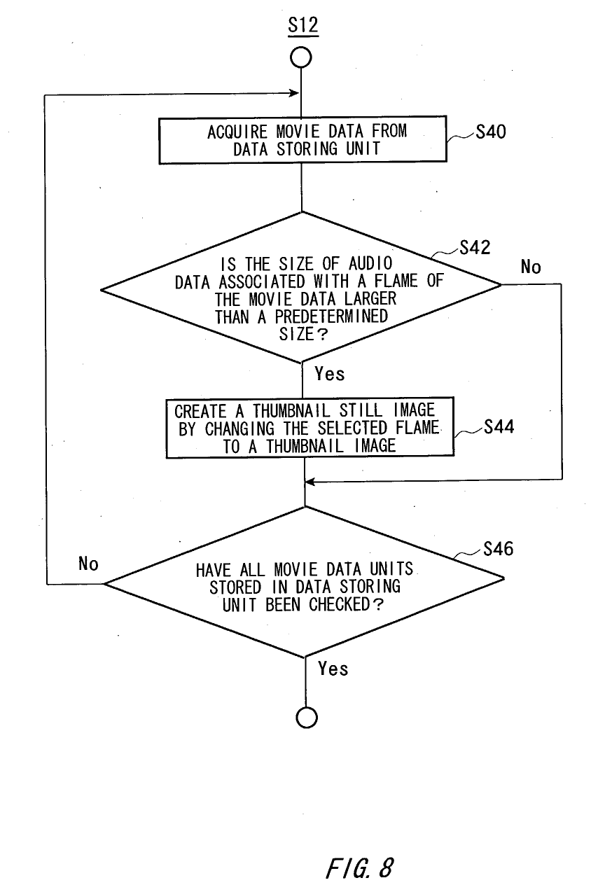

FIG. 8 shows an example of the more detailed procedure in Step S12 of FIGS. 5-7, for creating the thumbnail still image from the movie data. First, the thumbnail image creating unit 12 acquires the movie data from the data storing unit 10 (Step S40). Then, the thumbnail image creating unit 12 determines whether or not audio data associated with each of the flames of the movie data acquired from the data storing unit 10 has a size larger than a predetermined size (Step S42). In a case where the audio data associated with each flame of the movie data has a larger size than the predetermined size (Yes in Step S42), the thumbnail image creating unit 12 makes the flame with which the audio data having the larger size than the predetermined size is associated a thumbnail, thereby creating a thumbnail still image (Step S44).

On the other hand, in a case where the size of the audio data associated with each flame of the movie data is not larger than the predetermined size (No in Step S42), the thumbnail image creating unit 12 determines whether or not the size of the audio data associated with each flame of the movie data has been checked for all the movie data units stored in the data storing unit 10 (Step S46).

In a case where the size of the audio data associated with each flame has been checked for all the movie data units stored in the data storing unit 10 (Yes in Step S46), the thumbnail image creating unit 12 performs the process in Step S14 for simultaneously displaying the thumbnail still images. On the other hand, in a case where the size of the audio data associated with each flame of the movie data has not been checked yet for all the movie data units stored in the data storing unit 10 (No in Step S46), the thumbnail image creating unit 12 performs the process in Step S48 for acquiring the movie data from the data storing unit 10 again.

In the example shown in FIG. 8, the thumbnail image creating unit 12 selects one of the flames of the movie data, with which the audio data having a larger size than the predetermined size. Thus, the thumbnail display apparatus 100 can display one of the flames of the movie data, that is the best flame showing features of the movie data, on the display screen. Therefore, by using the thumbnail display apparatus 100, the user can browse the outline of the movie data in a short time.

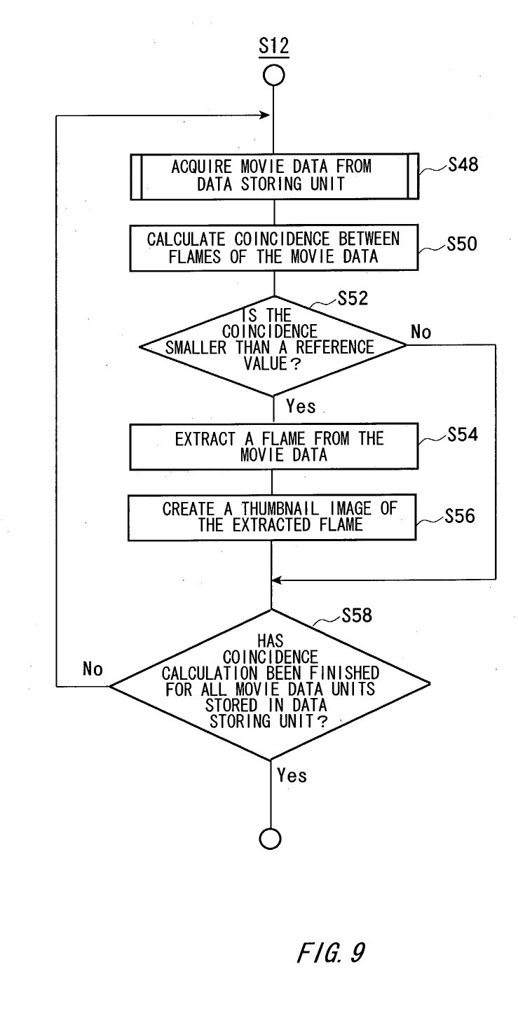

FIG. 9 shows another example of the more detailed procedure in Step S12 of FIGS. 5-7 for creating the thumbnail still image from the movie data. First, the thumbnail image creating unit 12 acquires the movie data from the data storing unit 10 (Step S48). Then, the coincidence calculating unit 28 calculates the coincidence between the adjacent ones of a plurality of flames constituting the movie data acquired from the data storing unit 10 (Step S50).

Next, the extracting unit 30 determines whether or not the coincidence calculated by the coincidence calculating unit 28 is smaller than a reference value (Step S52). In a case where the calculated coincidence is smaller than the reference value (Yes in Step 52), the extracting unit 30 extracts the latter flame from the movie data (Step S54). The thumbnail image creating unit 12 creates a thumbnail image of the flame extracted by the extracting unit 30 (Step S56). Then, the thumbnail image creating unit 12 determines whether or not the coincidence between the flames has been calculated for all the movie data units stored in the data storing unit 10 (Step S58).

On the other hand, in a case where the coincidence calculated by the coincidence calculating unit 28 is equal to or larger than the reference value (No in Step S52), the extracting unit 30 finishes the procedure, and the thumbnail image creating unit 12 determines whether or not the coincidence between the flames has been calculated for all the movie data units stored in the data storing unit 10 (Step S58).

In a case where the coincidence between the flames has been calculated for all the movie data units stored in the data storing unit 10 (Yes in Step S58), the thumbnail image creating unit 12 performs the process in Step S14 for displaying the thumbnail still images. On the other hand, in a case where the coincidence between the flames has not been calculated yet for all the movie data units stored in the data storing unit 10 (No in Step S58), the thumbnail image creating unit 12 performs the process in Step S48 for acquiring the movie data from the data storing unit 10 again.

When presenting the movie data containing the flames having the coincidence smaller than the reference value, the display unit 18 may present the movie data while the flames having the coincidence smaller than the reference value are subjected to image processing different from that for the flames having the coincidence higher than the reference value. For example, the display unit 18 may perform the image processing for causing the flames having the coincidence smaller than the reference value to gradually appear or disappear. It is likely that the flames having the coincidence smaller than the reference value are flames between different scenes of the movie. Therefore, by performing the image processing for causing the flames to gradually appear or disappear, it is possible to make the thumbnail movie more presentable.

In the example of FIG. 9, the extracting unit 30 extracts the flame having the coincidence with the adjacent flame smaller than the reference value from the flames of the movie data. Thus, the thumbnail display apparatus 100 can display the best flame of the movie data that shows the features of the movie data. Therefore, the user can browse the outline of desired movie data in a short time.

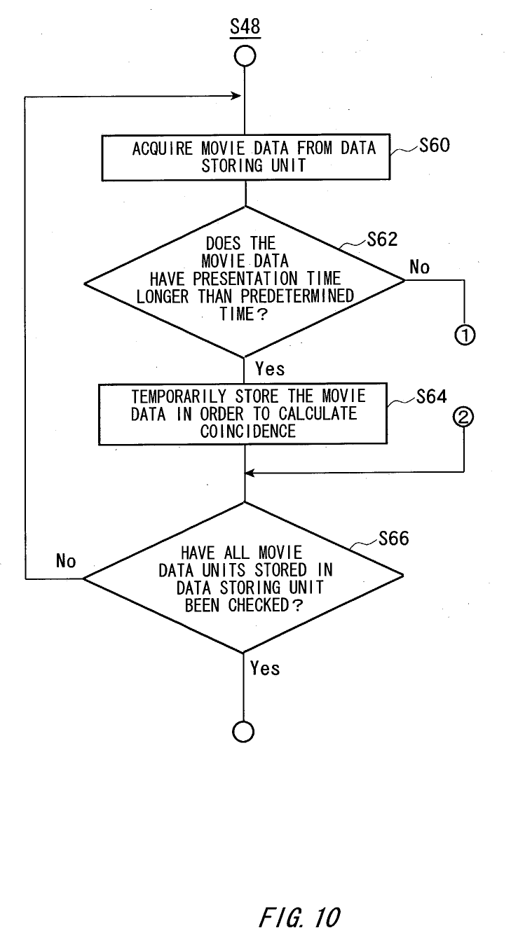

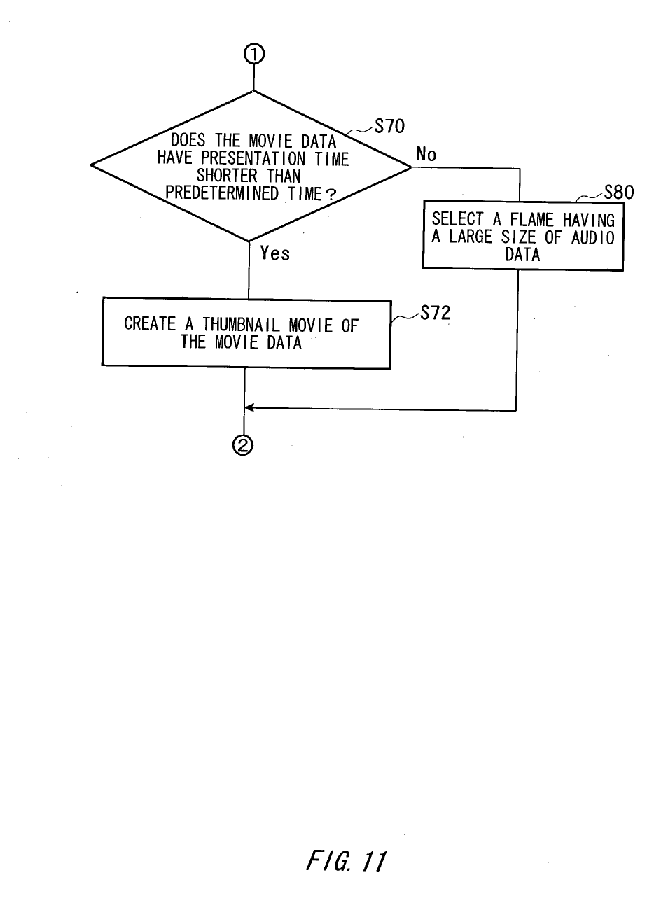

FIG. 10 shows an example of the more detailed procedure in Step S48 in FIG. 9 for acquiring the movie data from the data storing unit 10. The movie data selecting unit 32 acquires the movie data from the data storing unit 10 (Step S60). Then, the movie data selecting unit 32 determines whether or not the presentation time of the movie data acquired from the data storing unit is longer than predetermined time (Step S62). In a case where the presentation time of the movie data is longer than the predetermined time (Yes in Step S62), the movie data selecting unit 32 temporarily stores the movie data in order to calculate the coincidence between the flames of the movie data (Step S64). The procedure in a case where the presentation time of the movie data is equal to or shorter than the predetermined time (No in Step S62) will be described later, referring to FIG. 11 and therefore the description thereof is omitted here.

Next, the movie data selecting unit 32 determines whether or not the presentation time has been checked for all the movie data units stored in the data storing unit 10 (Step S66). In a case where the presentation time has been checked for all the movie data units stored in the data storing unit 10 (Yes in Step S66), the movie data selecting unit 32 finishes the procedure. On the other hand, in a case where the presentation time has not been checked yet for all the movie data units stored in the data storing unit 10 (No in Step S66), the thumbnail image creating unit 12 performs the process in Step S60 for acquiring the movie data from the data storing unit 10.

The coincidence calculating unit 28 calculates the coincidence only for the movie data having the presentation time longer than the predetermined time acquired from the data storing unit 10. Thus, the thumbnail display apparatus 100 can extract a typical movie data unit from a plurality of movie data units only so as to calculate the coincidence for the typical movie data unit. Therefore, the thumbnail display apparatus 100 can reduce a time period required for calculating a plurality of coincidences.

FIG. 11 shows a more detailed procedure between (1) and (2) in FIG. 10. First, the thumbnail image creating unit 12 determines whether or not the presentation time of the movie data stored in the data storing unit 10 is shorter than the predetermined time (Step S70). In a case where the presentation time of the movie data is shorter than the predetermined time, the thumbnail image creating unit 12 creates a thumbnail movie by making the movie data thumbnail (Step S72). On the other hand, in a case where the presentation time of the movie data is shorter than the predetermined time, the thumbnail image creating unit 12 selects one of the flames of the movie data, with which the audio data having a size larger than a predetermined size is associated (Step S80). Since the thumbnail display apparatus 100 displays the thumbnail movie in the case where the presentation time of the movie data is shorter than the predetermined time, the user can browse the outline of the desired movie data in a short time.

As is apparent from the above, according to the present invention, the user can browse the summary of the desired movie data in a short time.

Although the present invention has been described by way of exemplary embodiments, it should be understood that those skilled in the art might make many changes and substitutions without departing from the spirit and the scope of the present invention which is defined only by the appended claims.

What is claimed is:

1. A thumbnail display apparatus for displaying thumbnail images of a plurality of movies, comprising:
a data storing unit operable to store a plurality of movie data units corresponding to said movies;
a thumbnail image creating unit operable to create a plurality of thumbnail still images respectively corresponding to said movie data units stored in said data storing unit; and
a displaying unit operable to simultaneously display said plurality of thumbnail still images created by said thumbnail image creating unit at different positions on a display screen for allowing any of said thumbnail still images to be selected, wherein
said thumbnail image crating unit acquires a thumbnail movie obtained by making movie data corresponding to said selected thumbnail still image thumbnail, and
said displaying unit displays said thumbnail movie at a position at which said selected thumbnail still image was arranged and displays other thumbnail still images that were not selected at different positions on said display screen simultaneously.

2. A thumbnail display apparatus as claimed in claim 1, further comprising a thumbnail image storing unit operable to store said plurality of thumbnail still images created by said thumbnail image creating unit in such a manner that said plurality of thumbnail still images correspond to associated movie-data identifying information units for identifying said plurality of movie data units, respectively, wherein
said thumbnail image storing unit stores audio data units to correspond to said movie-data identifying information units, respectively,
said thumbnail image creating unit acquires, when a plurality of ones of said plurality of thumbnail still images were selected, audio data units corresponding to movie-data identifying information units corresponding to said selected thumbnail still images, respectively, from said thumbnail image storing unit, and
said displaying unit outputs audio in such a manner that said audio is heard from positions corresponding to positions at which said selected thumbnail still images were arranged.

3. A thumbnail display apparatus as claimed in claim 1, further comprising a thumbnail selecting unit operable to select one of said plurality of thumbnail still images on said display screen, wherein
said thumbnail image creating unit acquires, in a case where a position indicated by said thumbnail selecting unit overlaps a position of said selected one of said thumbnail still images on said display screen of said display unit, said thumbnail movie corresponding to said selected thumbnail still image, and
said display unit displays said thumbnail movie created by said thumbnail image creating unit at said position at which said selected thumbnail still image was arranged on said display screen.

4. A thumbnail display apparatus as claimed in claim 1, further comprising a thumbnail selecting unit operable to select one of said plurality of thumbnail still images on said display screen, wherein
said thumbnail image storing unit stores a plurality of units of thumbnail image identifying information for identifying said plurality of thumbnail still images to correspond to one another,
said thumbnail creating unit creates, in a case where said thumbnail selecting units selected any of said plurality of thumbnail still images, thumbnail movies of movie data units that are respectively associated with said thumbnail image identifying information units corresponding to one another, and
said display unit displays said thumbnail movies created by said thumbnail image creating unit simultaneously.

5. A thumbnail display apparatus as claimed in claim 1, further comprising:
a thumbnail image storing unit operable to store said plurality of thumbnail still images created by said thumbnail image creating unit; and
a thumbnail selecting unit operable to select one of said plurality of thumbnail still images on said display screen, wherein
said thumbnail creating unit acquires, in a case where said thumbnail selecting unit stopped selecting said one of said plurality of thumbnail still images, acquires from said thumbnail image storing unit said thumbnail still image that was presented on said display screen at a time when said selected one of said plurality of thumbnail still images was selected, and
said display unit displays said thumbnail still image acquired by said thumbnail image creating unit at a position on said display screen at which said selected one of said plurality of thumbnail still images was arranged.

6. A thumbnail display apparatus as claimed in claim 1, further comprising a thumbnail selecting unit operable to select one of said plurality of thumbnail still images, wherein
said thumbnail image creating unit creates, when said thumbnail selecting unit stopped selecting said one of said plurality of thumbnail still images, a thumbnail image of a flame that was presented at a time at which selection of said one of said plurality of thumbnail still images was stopped, and causes said display unit to display said created thumbnail image.

7. A thumbnail display apparatus as claimed in claim 1, wherein
said data storing unit stores audio data to be associated with each of flames of each movie data unit, and
said thumbnail image creating unit selects flames of said movie data units, with each of which said audio data having a larger size than a predetermined data size is associated, and creates said thumbnail still image by making said selected flames thumbnail.

8. A thumbnail display apparatus as claimed in claim 1, further comprising:
a calculating unit operable to calculate a coincidence between adjacent flames of a plurality of flames constituting each movie data unit stored in said data storing unit; and
an extracting unit operable to determine whether or not said coincidence is smaller than a reference value and to extract a latter one of said adjacent flames for which said coincidence was determined to be smaller than said reference value, wherein
said thumbnail image creating unit creates a thumbnail image of said latter flame extracted by said extracting unit as a thumbnail still image corresponding to said movie data.

9. A thumbnail display apparatus as claimed in claim 8, further comprising a movie data selecting unit operable to select a movie data unit having presentation time larger than predetermined time, from said movie data units stored in said data storing unit, wherein
said calculating unit calculates said coincidence between said adjacent flames only for said movie data unit selected by said movie data selecting unit,
said extracting unit extracts a latter one of said adjacent flames for which said coincidence was determined to be smaller than said reference value, and
said thumbnail image creating unit creates a thumbnail image of said latter flame extracted by said extracting unit as a thumbnail still image corresponding to said movie data unit.

10. A thumbnail display apparatus as claimed in claim 9, wherein said display unit presents said movie data unit containing said flames for which said coincidence was determined to be smaller than said reference value in such a manner that said flames for which said coincidence was determined to be smaller than said reference value were subjected to image processing different from that for flames for which said coincidence was determined to be larger than said reference value.

11. A thumbnail display apparatus as claimed in claim 1, wherein said thumbnail image creating unit determines whether or not presentation time of each of said movie data units stored in said data storing unit is shorter than predetermined time, and creates, for movie data unit for which said presentation time was determined to be shorter than said predetermined time, a thumbnail movie by making said movie data unit thumbnail.

12. A thumbnail display program for causing a computer to display thumbnail images of a plurality of movies, comprising:
a data storing module instructing said computer to store a plurality of movie data units corresponding to said movies;
a thumbnail image creating module instructing said computer to create a plurality of thumbnail still images respectively corresponding to said movie data units stored; and
a display module instructing said computer to simultaneously display said plurality of thumbnail still images created in accordance with the instruction from said thumbnail image creating module at different positions on a display screen for allowing any of said thumbnail still images to be selected, wherein
said thumbnail image creating module instructs said computer to acquire a thumbnail movie obtained by making movie data corresponding to said selected thumbnail still image thumbnail, and
said display module instructs said computer to display said thumbnail movie at a position at which said selected thumbnail still image was arranged and to display other thumbnail still images that were not selected at different positions on said display screen simultaneously.

13. A thumbnail display program as claimed in claim 12, further comprising a thumbnail image storing module instructing said computer to store said plurality of thumbnail still images created in accordance with the instruction from said thumbnail image creating module in such a manner that said plurality of thumbnail still images correspond to associated movie-data identifying information units for identifying said plurality of movie data units, respectively, wherein
said thumbnail image storing module instructs said computer to store audio data units to correspond to said movie-data identifying information units, respectively,
said thumbnail image creating module instructs said computer to acquire, when a plurality of ones of said plurality of thumbnail still images were selected, audio data units corresponding to movie-data identifying information units corresponding to said selected thumbnail still images, respectively, from said thumbnail image storing module, and
said display module instructs said computer to output audio in such a manner that said audio is heard from positions corresponding to positions at which said selected thumbnail still images were arranged.

14. A thumbnail display program as claimed in claim 12, further comprising a thumbnail selecting module operable to select one of said plurality of thumbnail still images on said display screen, wherein
said thumbnail image creating module instructs said computer to acquire, in a case where a position indicated by said thumbnail selecting module overlaps a position of said selected one of said thumbnail still images on said display screen, said thumbnail movie corresponding to said selected thumbnail still image, and
said display module instructs said computer to display said thumbnail movie created by said thumbnail image creating module at said position at which said selected thumbnail still image was arranged on said display screen.

15. A thumbnail display program as claimed in claim 12, further comprising a thumbnail selecting module operable to select one of said plurality of thumbnail still images on said display screen, wherein
said thumbnail image storing module instructs said computer to store a plurality of units of thumbnail image identifying information for identifying said plurality of thumbnail still images to correspond to one another,
in a case where said thumbnail selecting units selected any of said plurality of thumbnail still images, said thumbnail creating module instructs said computer to create thumbnail movies of movie data units that are respectively associated with said thumbnail image identifying information units corresponding to one another, and
said display module instructs said computer to simultaneously display said thumbnail movies thus created.

16. A thumbnail display program as claimed in claim 12, further comprising:
a thumbnail image storing module instructing said computer to store said plurality of thumbnail still images created in accordance with the instruction from said thumbnail image creating module; and
a thumbnail selecting module operable to select one of said plurality of thumbnail still images on said display screen, wherein
in a case where said thumbnail selecting module stopped selecting said one of said plurality of thumbnail still images, said thumbnail creating module instructs said computer to acquire from said thumbnail image storing module said thumbnail still image that was presented on said display screen at a time when said selected one of said plurality of thumbnail still images was selected, and
said display module instructs said computer to display said thumbnail still image thus acquired at a position on said display screen at which said selected one of said plurality of thumbnail still images was arranged.

17. A thumbnail display program as claimed in claim 12, further comprising a thumbnail selecting module operable to select one of said plurality of thumbnail still images, wherein
when said thumbnail selecting module stopped selecting said one of said plurality of thumbnail still images, said thumbnail image creating module instructs said computer to create a thumbnail image of a flame that was presented at a time at which selection of said one of said plurality of thumbnail still images was stopped, and instructs said computer to display said created thumbnail image.

18. A thumbnail display program as claimed in claim 12, wherein
said data storing module instructs said computer to store audio data to be associated with each of flames of each movie data unit, and
said thumbnail image creating module instructs said computer to select flames of said movie data units, with each of which said audio data having a larger size than a predetermined data size is associated, and instructs said computer to create said thumbnail still image by making said selected flames thumbnail.

19. A thumbnail display program as claimed in claim 12, further comprising:
a calculating module instructing said computer to calculate a coincidence between adjacent flames of a plurality of flames constituting each movie data unit stored in accordance with the instruction from said data storing module; and
an extracting module instructing said computer to determine whether or not said coincidence is smaller than a reference value and to extract a latter one of said adjacent flames for which said coincidence was determined to be smaller than said reference value, wherein
said thumbnail image creating module instructs said computer to create a thumbnail image of said latter flame thus extracted as a thumbnail still image corresponding to said movie data.

20. A thumbnail display program as claimed in claim 19, further comprising a movie data selecting module instructing said computer to select a movie data unit having presentation time larger than predetermined time, from said stored movie data units, wherein
said calculating module instructs said computer to calculate said coincidence between said adjacent flames only for said movie data unit selected by said movie data selecting module,
said extracting module instructs said computer to extract a latter one of said adjacent flames for which said coincidence was determined to be smaller than said reference value, and
said thumbnail image creating module instructs said computer to create a thumbnail image of said latter flame extracted by said extracting unit as a thumbnail still image corresponding to said movie data unit.

21. A thumbnail display program as claimed in claim 20, wherein said display module instructs said computer to present said movie data unit containing said flames for which said coincidence was determined to be smaller than said reference value in such a manner that said flames for which said coincidence was determined to be smaller than said reference value were subjected to image processing different from that for flames for which said coincidence was determined to be larger than said reference value.

22. A thumbnail display program as claimed in claim 12, wherein said thumbnail image creating module instructs said computer to determine whether or not presentation time of each of said stored movie data units is shorter than predetermined time, and instructs said computer to create, for movie data unit for which said presentation time was determined to be shorter than said predetermined time, a thumbnail movie by making said movie data unit thumbnail.
